(19) United States
(12) Patent Application Publication
(10) Pub. No.: US 2006/0114328 A1
(43) Pub. Date: Jun. 1, 2006

(54) Apparatus and method for processing images taking into consideration light reflection, and a computer readable medium storing computer program therefor

(75) Inventors: Jungbae Kim, Yongin-si (KR); Euihyeon Hwang, Bucheon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/288,155

(22) Filed: Nov. 29, 2005

(30) Foreign Application Priority Data
Nov. 29, 2004 (KR) 10-2004-0098690

(51) Int. Cl. H04N 5/225; H04N 9/04

(52) U.S. Cl. 348/207.99

(57) ABSTRACT

An image processing method and an image processing apparatus taking into consideration of light reflection, and a computer readable recording medium storing a program executing the same are provided. The image processing apparatus for irradiating light beams onto a light-transmitting object and a subject located behind the light-transmitting object and photographing the light-transmitting object and the subject to obtain their images includes a recovery controller generating control signals for changing spatial distribution of the irradiated light beams; an image photographing unit irradiating the light beams in response to the control signals and photographing the light-transmitting object and the subject; and an image recovery unit replacing replacement target data among original image data obtained from the image photographing unit by photographing the subject and the light-transmitting object with reflection-free data to generate recovered image data, wherein the replacement target data is a portion of the original image data of which pixel values are different from those of intermediate image data obtained by photographing the subject and the light-transmitting object after changing spatial distribution of the irradiated light beams, and the reflection-free data are a portion of the intermediate image data of which pixel values are different from those of the original image data. Therefore, a face recognition apparatus or an iris recognition apparatus using infrared rays irradiated onto a face can be appropriately applied to a person wearing glasses.

### CROSS-REFERENCE TO RELATED APPLICATIONS

This application claims the benefit of Korean Patent Application No. 10-2004-0098690, filed on Nov. 29, 2004, in the Korean Intellectual Property Office, the disclosure of which is incorporated herein in its entirety by reference.

### BACKGROUND OF THE INVENTION

1. Field of the Invention

The present invention relates to an image processing for removing mirror reflection regions formed on a lens of glasses by irradiated light beams, and more particularly, to an image processing apparatus and an image processing method for adjusting spatial distribution of the light beams irradiated onto a light-transmitting object to eliminate mirror reflection regions formed on the light-transmitting object, and a computer readable recording medium storing a computer program executing the same

2. Description of the Related Art

Various biometric methods and systems have been developed to identify or authenticate a person based on human biomedical properties. Out of them, a method of authenticating a person by photographing a face or eyes, analyzing characteristic patterns of the face, or retinal veins or irises of the eyes is already commercially available.

Since there are increasing demands for such a biometric system capable of reliably authenticating a person who tries to access a security system, it is expected that such a biometric system will be widely used in our lives in near future.

Typically, such a biometric system is required to have a subject, a camera, and a computer for recognizing and analyzing the photographed image. However, a conventional face recognition method was susceptible to external lighting. Since the amount of the external lighting is very variable depending on where a subject is placed or when a subject is photographed, a conventional face recognition system may appropriately recognize a person in the day time but inappropriately recognize the person in the night time.

In order to solve the aforementioned problem, a method of recognizing irises or a face by using a camera having an infrared light source irradiating an infrared light beam over a predetermined external light intensity onto the subject has been proposed. However, such a method cannot be applied to a lot of persons wearing glasses or contact lenses.

In other words, the problem of the conventional method of recognizing a face or irises by using a camera having an infrared light source is that the face or irises cannot be appropriately recognized due to a mirror reflection region generated by reflection of the infrared light beams irradiated onto the lenses of glasses.

It has been known that the amount of the light beams mirror-reflected on the surfaces of the glasses is at least a thousand times of the amount of the light beams diffusion-reflected on the normal eyes.

Accordingly, as the amount of the light beams mirror-reflected on the glasses becomes larger, pixels of image sensors in the camera photographing the mirror-reflected regions are saturated, so that the entire information on the images of the eyes covered up by the mirror-reflected regions is lost. In addition, pixels surrounding the mirror-reflected regions can be contaminated by the saturated pixels due to a blooming phenomenon. This phenomenon can be generated by bad insulation of the pixels of a charge-coupled device (CCD), which is a typical electronic imager.

In order to solve the problem that irises of the eyes can not be accurately recognized in the photographed face image due to the mirror reflection, Japanese Patent Application Laid-open No. 1996-185503 proposes a method of accurately searching iris images by applying different threshold values to the iris areas and the glasses areas based on the fact that their irradiation amounts are different from each other. Although this method is useful to search positions of irises, this method cannot generate the images in which the mirror reflection effect is eliminated.

As a result, a conventional method urges a user to take off her/his glasses to obtain clear images of eyes. This is cumbersome to a user. Also, there is no alternative method when a user refuses to take off her/his glasses or wants to skip the recognition system.

### SUMMARY OF THE INVENTION

Additional aspects, features, and/or advantages of the invention will be set forth in part in the description which follows and, in part, will be apparent from the description, or may be learned by practice of the invention.

The present invention provides an image processing apparatus for eliminating mirror reflection regions on a light-transmitting object by adjusting spatial distribution of the light beams irradiated onto the light-transmitting object.

Also, the present invention provides an image processing method of eliminating mirror reflection regions on a light-transmitting object by adjusting spatial distribution of the light beams irradiated onto the light-transmitting object.

Also, the present invention provides a computer readable recording medium storing a computer program executing a method of eliminating mirror reflection regions on a light-transmitting object by adjusting spatial distribution of the light beams irradiated onto the light-transmitting object.

According to an aspect of the present invention, there is provided an image processing apparatus for irradiating light beams onto a light-transmitting object and a subject located behind the light-transmitting object and photographing the light-transmitting object and the subject to obtain their images, the image processing apparatus comprising: a recovery controller generating control signals for changing spatial distribution of the irradiated light beams; an image photographing unit irradiating the light beams in response to the control signals and photographing the light-transmitting object and the subject; and an image recovery unit replacing replacement target data among original image data obtained from the image photographing unit by photographing the subject and the light-transmitting object with reflection-free data to generate recovered image data, wherein the replacement target data is a portion of the original image data of which values are different from those of intermediate image data obtained by photographing the subject and the light-transmitting object after changing spatial distribution of the irradiated light beams, and the reflection-free data is a portion of the intermediate image data of which value are different from those of the original image data.

The recovery controller instructs the image photographing unit to photograph the light-transmitting object and the subject by sequentially changing the spatial distribution of the irradiated light beam, and the image recovery unit generates the recovered image data by replacing the replacement target data among the original image data with the reflection-free data.

According to another aspect of the present invention, there is provided an image processing method for obtaining images of a light-transmitting object and a subject located behind the light-transmitting object, the image processing method comprising: obtaining original image data by irradiating light beams onto the light-transmitting object and the subject and photographing the light-transmitting object and the subject; obtaining intermediate image data by photographing the light-transmitting object and the subject after changing spatial distribution of the irradiated light beams; and generating recovered image data by replacing replacement target data among the original image data with reflection-free data, wherein the replacement target data are a portion of the original image data of which values are different from those of the intermediate image data, and the reflection-free data are a portion of the intermediate image data of which values are different from those of the original image data.

The intermediate image data may be obtained by changing spatial distribution of the irradiated light beams in a predetermined number of times and photographing the light-transmitting object and the subject whenever the spatial distribution is changed, so that the number of the intermediate image data corresponds to the predetermined number of times, and the recovered image data may be generated by replacing the replacement target data among the original image data with the reflection-free data corresponding to the replacement target data.

According to still another aspect of the present invention, there is provided a computer readable recording medium storing a program executing an image processing method for obtaining images of a light-transmitting object and a subject located behind the light-transmitting object, the image processing method comprising: obtaining original image data by irradiating light beams onto the light-transmitting object and the subject and photographing the light-transmitting object and the subject; obtaining intermediate image data by photographing the light-transmitting object and the subject after changing spatial distribution of the irradiated light beams; and generating recovered image data by replacing replacement target data among the original image data with reflection-free data, wherein the replacement target data are a portion of the original image data of which values are different from those of the intermediate image data, and the reflection-free data are a portion of the intermediate image data of which values are different from those of the original image data.

According to another aspect of the present invention, there is provided an image processing apparatus for irradiating light beams onto a light-transmitting object and a subject located behind the light-transmitting object and photographing the light-transmitting object and the subject to obtain their images, the image processing apparatus comprising: a recovery controller generating control signals for changing spatial distribution of the irradiated light beams; an image photographing unit irradiating the light beams in response to control signals and photographing the light-transmitting object and the subject whenever the spatial distribution is changed to obtain original image data and intermediate image data; and an image recovery unit replacing replacement target data among original image data, obtained from the image photographing unit by photographing the subject and the light-transmitting object, with reflection-free data to generate recovered image data, wherein the replacement target data and reflection-free data is determined based on comparison of the original image data with the intermediate image data.

According to another aspect of the present invention, there is provided an image processing method of obtaining images of a light-transmitting object and a subject located behind the light-transmitting object, the image processing method comprising: obtaining original image data by irradiating light beams onto the light-transmitting object and the subject and photographing the light-transmitting object and the subject; obtaining intermediate image data by photographing the light-transmitting object and the subject after changing spatial distribution of the irradiated light beams; and generating recovered image data by replacing replacement target data among the original image data with reflection-free data, wherein the replacement target data and the reflection-free data are determined based on a comparison of the original image data and the intermediate image data.

According to another aspect of the present invention, there is provided at least one computer readable medium storing instructions that control at least one processor to perform a method comprising: obtaining original image data by irradiating light beams onto the light-transmitting object and the subject and photographing the light-transmitting object and the subject; obtaining intermediate image data by photographing the light-transmitting object and the subject after changing spatial distribution of the irradiated light beams; and generating recovered image data by replacing replacement target data among the original image data with reflection-free data, wherein the replacement target data and the reflection-free data are determined based on a comparison of the original image data and the intermediate image data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a schematic diagram illustrating an exemplary face recognition apparatus;

FIG. 2 is a block diagram illustrating an image processing apparatus taking into consideration of light reflection according to an exemplary embodiment of the present invention;

FIG. 3 is a flowchart illustrating an exemplary embodiment of an image processing method taking into consideration of light reflection according to the present invention;

FIG. 4 is a flowchart illustrating another exemplary embodiment of an image processing method taking into consideration of light reflection according to the present invention;

FIG. 5 is a schematic perspective view illustrating an exemplary embodiment of an image photographing unit 210 that can be included in the image processing apparatus shown in FIG. 2 according to the present invention;

FIGS. 6A, 6B, and 6C illustrate examples of original image data, intermediate image data, and recovered image data according to an exemplary embodiment of the present invention;

FIG. 7 is a flowchart for describing an exemplary embodiment of the present invention for operation 330 shown in FIG. 3 and operation 430 shown in FIG. 4;

FIG. 8 is a detailed block diagram illustrating an exemplary embodiment of an image recovery unit 240 of FIG. 2; and

FIGS. 9A through 9G illustrate an exemplary embodiment of a process of eliminating mirror reflection regions in the image processing apparatus according to the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

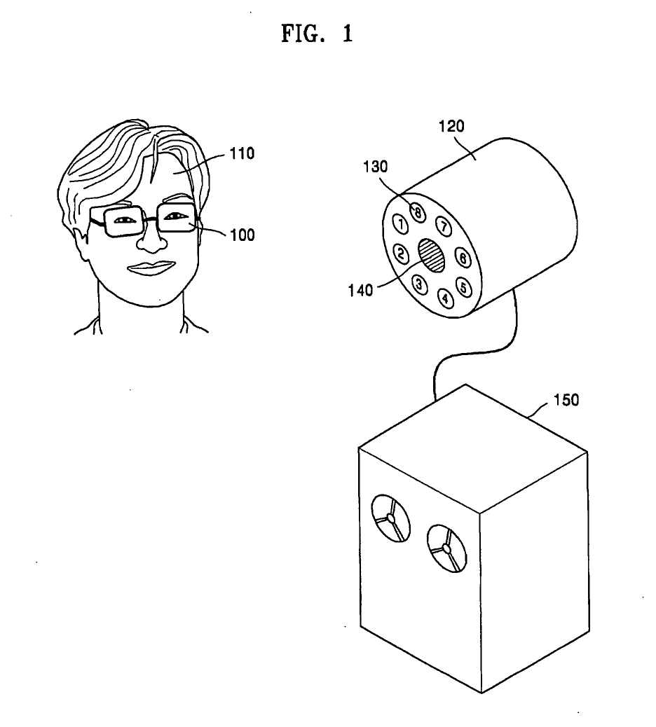

FIG. 1 is a schematic diagram illustrating an exemplary face recognition apparatus. The face recognition apparatus includes a camera module 120 and an image recovery apparatus 150. The camera module includes a plurality of light sources 130 and a lens assembly 140 for photographing a face 110 wearing glasses 100.

On the glasses 100, mirror reflection regions are generated by the light beams irradiated from the light sources 130. If the image recovery apparatus 150 cannot appropriately recover the image having the mirror reflection regions, a person corresponding to the photographed image cannot be authenticated. The face 110 is an example of a subject, and a lens of a pair of glasses 100 is an example of a light-transmitting object capable of transmitting the irradiated light beams.

Since the subject 110 is placed behind the light-transmitting object 100, the irradiated light beams arrive at the light-transmitting object 100 first and then arrive at the subject 110.

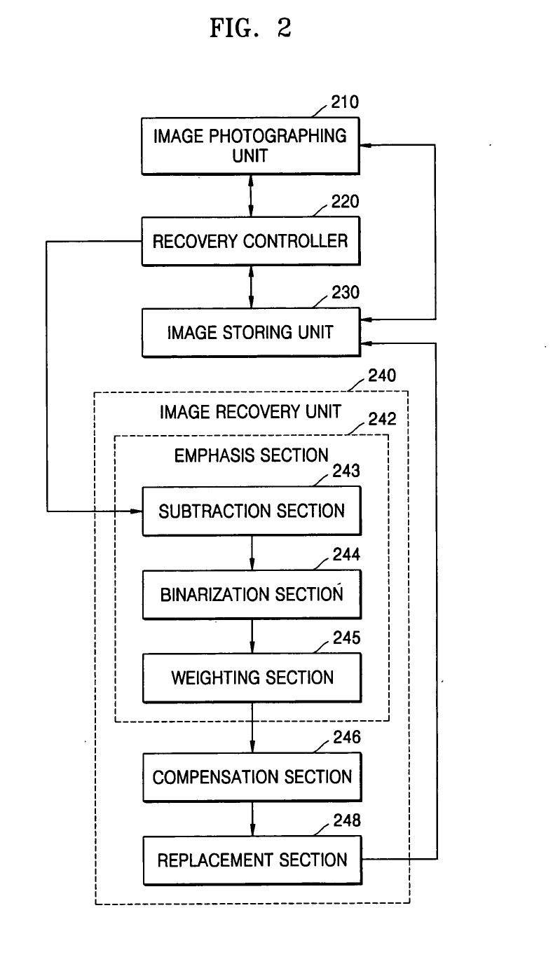

FIG. 2 is a block diagram illustrating an image processing apparatus taking into consideration light reflection according to an exemplary embodiment of the present invention. The image processing apparatus includes an image photographing unit 210, a recovery controller 220, an image storing unit 230, and an image recovery unit 240.

The image recovery unit 240 includes an emphasis section 242, a compensation section 246, and a replacement section 248. The emphasis section 242 includes a subtraction section 243, a binarization section 244, and a weighting section 245.

The image photographing unit 210 controls spatial distribution of the irradiated light beams and photographs the subject 110 and the light-transmitting object 100. Preferably, the image photographing unit 210 photographs the subject 110 and the light-transmitting object 100 through lens assembly 140. The camera 120 is an example of the image photographing unit 210.

Around the lens assembly 140, one or more light sources 130 are arranged to irradiate the light beams onto the subject 110 and the light-transmitting object 100 when turned on. When the light sources 130 output the light beams, mirror reflection regions are generated by the light beams irradiated onto the light-transmitting object 100. Preferably, one or more light sources 130 are provided.

The image photographed by the image photographing unit 210 is transmitted to the recovery controller 220.

The recovery controller 220 is adapted to control the image storing unit 230 and the image recovery unit 240 to generate an image having no mirror reflection effect from the image transmitted from the image photographing unit 210.

In addition, the recovery controller 220 instructs to turn on/off the light sources 130 and operates the image photographing unit 210. The recovery controller 220 is adapted to change spatial distribution of the light beams irradiated from the image photographing unit 210 onto the light-transmitting object 100 by controlling on/off states of one or more light sources 130. Preferably, the image photographing unit 210 is adapted to photograph the subject 110 and the light-transmitting object 100 whenever the spatial distribution of the light beams irradiated onto the light-transmitting object 100 is changed.

The image storing unit 230 stores original image data directly obtained from the image photographing unit 210, intermediate image data, and recovered image data obtained from the image recovery unit 240. The image storing unit 230 may also store original image data obtained from the image photographing unit 210 by way of the recovery controller 220.

The original image data are the image data having a mirror reflection region. Preferably, the original image data are obtained from the image photographing unit 210 while all the light sources 130 are turned on.

The intermediate image data are the image data obtained from the image photographing unit 210 after the spatial distribution of the light beams irradiated onto the light-transmitting object 100 is changed relative to the spatial distribution when the original image data are obtained. Preferably, the intermediate image data are obtained from the image photographing unit 210 whenever a selected group of the light sources 130 are turned on.

The recovered image data are the image data generated by using the original image data and the intermediate image data. That is, the recovered image data are the original image data from which the mirror reflection effect is eliminated. The image recovery unit 240 can more effectively eliminate the mirror reflection effect by using a plurality of intermediate image data obtained from the image photographing unit 210 and the recovery controller 220 by changing the spatial distribution of the light beams irradiated onto the light-transmitting object 100.

More specifically, the recovered image data are generated by replacing replacement target data among the original image data obtained from the image photographing unit 210, with reflection-free data. The replacement target data are a portion of the original image data of which pixel values are different from those of the intermediate image data. The reflection-free data are a portion of the intermediate image data of which pixel values are different from those of the original image data.

The image recovery unit 240 generates the recovered image data by eliminating mirror reflection effect from the original image data. The recovery controller 220 instructs the subtraction section 243 of the image recovery unit 240 to generate the recovered image data.

The emphasis section 242 of the image recovery unit 240 generates the reflection-free data. In this case, the reflection-free data do not mean the subtraction data, but mean the data obtained by binarizing the subtraction data and multiplying the binarized subtraction data by the intermediate image data.

The subtraction section 243 of the emphasis section 242 generates the subtraction data. The subtraction data are the data representing differences between the intermediate image data and the original image data.

The binarization section 244 of the emphasis section 242 binarizes the subtraction data to search the subtraction data to be emphasized. The portion of the original image data of which pixel values are different from those of the intermediate image data may include the data corresponding to the regions of the subject 110 as well as the data corresponding to the regions of the mirror reflection regions.

Preferably, the data to be recovered from the original image data are the data corresponding to the regions of the light-transmitting object 100. Therefore, the binarization section 244 of the emphasis section 242 binarizes the subtraction data on a basis of a predetermined threshold value, so that the subtraction data corresponding to the regions of the light-transmitting object 100 are discriminated. In this case, the image recovery unit 240 may generate the recovered image data by replacing the replacement target data among the original image data with the reflection-free data. Also, the reflection-free data are a portion of the intermediate image data of which pixel values are different from those of the original image data.

Preferably, the data to be recovered from the original image data are the data corresponding to the mirror reflection regions of the light-transmitting object 100. The original image data are pixel values of the original image, and the intermediate image data are pixel values of the intermediate image. The mirror reflection region has a largest difference between the original image data and the intermediate image data. Therefore, the binarization section 244 of the emphasis section 242 binarizes the subtraction data on a basis of a predetermined threshold value, so that only the subtraction data corresponding to the mirror reflection regions of the light-transmitting object 100 are preferably discriminated.

The weighting section 245 of the emphasis section 242 is adapted to multiply the binarized subtraction data by the intermediate image data. When the binarization section 244 discriminates the subtraction data corresponding to the mirror reflection regions of the light-transmitting object 100 from all the subtraction data, the weighting section 245 discriminates the intermediate image data corresponding to the mirror reflection regions from all of the intermediate image data. The intermediate image data discriminated by the weighting section 245 are the reflection-free data. The reflection-free data are the data obtained by eliminating the mirror reflection effect from the original image data corresponding to the mirror reflection regions of the original image.

The compensation section 246 of the image recovery unit 240 is adapted to add or subtract a predetermined value to or from the reflection-free data generated from the emphasis section 242 to generate compensated reflection-free data. The predetermined value may be a mean value of the subtraction data.

According to an exemplary embodiment of the present invention, the replacement section 248 of the image recovery unit 240 replaces the replacement target data among the original image data with the reflection-free data to generate the recovered image data. In this case, the reflection-free data may be a portion of the intermediate image data of which pixel values are different from those of the original image data, or may be a portion of the intermediate image data corresponding to the regions of the light-transmitting object 100, of which pixel values are different from those of the original image data. Preferably, the reflection-free data are generated by the emphasis section 242.

According to another exemplary embodiment of the present invention, the replacement section 248 of the image recovery unit 240 is adapted to replace the replacement target data among the original image data with the compensated reflection-free data to generate the recovered image data.

The recovered image data generated from the replacement section 248 of the image recovery unit 240 are stored in the image storing unit 230.

Meanwhile, if the present invention is applied to a face recognition apparatus, the face corresponds to the subject 110, and the lenses of a pair of glasses correspond to the light-transmitting object 100. If the present invention is an iris recognition system, the irises correspond to the subject 110, and the lenses of a pair of glasses correspond to the light-transmitting object 100. Therefore, the present invention may be applied to both the face recognition apparatus and the iris recognition apparatus.

Accordingly, the subject 110 of the present invention is not limited by irises or faces, and the light-transmitting of the present invention is not limited by glasses or contact lenses. For example, the present invention may be applied to a variety of applications photographing a subject packaged or covered by a light-transmitting object 100 such as a glass bottle and blister package. The light-transmitting object 100 is not necessary to be transparent, and may be an object having a mirror reflection region when irradiated by the light.

The light source 130 may be configured to irradiate visible light beams as well as invisible light beams such as infrared rays. Particularly, an iris recognition system uses infrared rays.

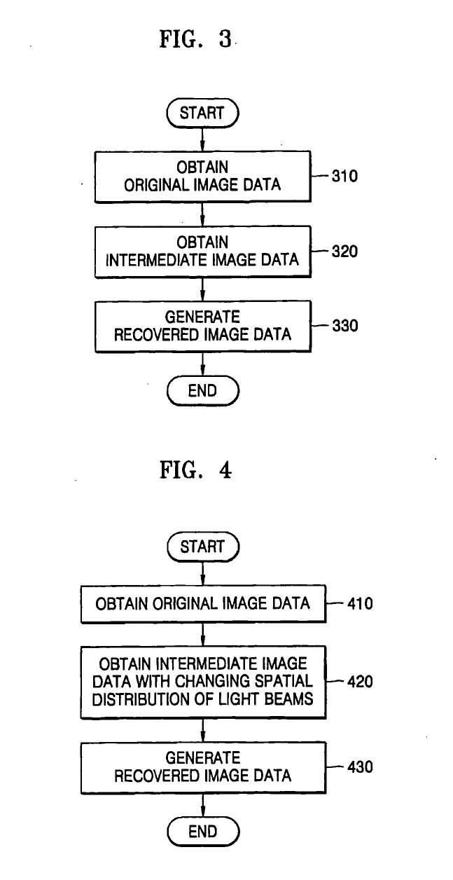

FIG. 3 is a flowchart illustrating an exemplary image processing method taking into consideration light reflection according to the present invention. An exemplary image processing method according to the present invention includes obtaining original image data (310), obtaining intermediate image data (320), and generating recovered image data (330).

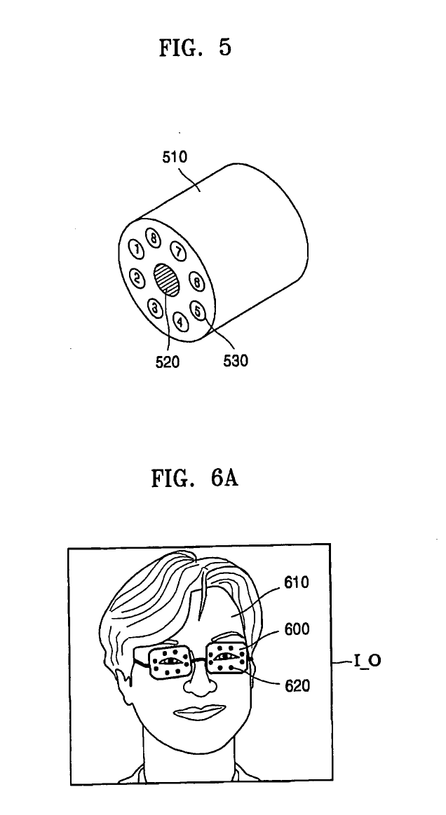

FIG. 4 is a flowchart illustrating another exemplary image processing method taking into consideration light reflection according to the present invention. An exemplary image processing method according to the present invention includes obtaining original image data (410), obtaining intermediate image data with changing spatial distribution of light beams (420), and generating the recovered image data (430).

The image photographing unit 210 turns on the light sources 130 to irradiate the light-transmitting object 100 and the subject 110, and photographs the light-transmitting object 100 and the subject 110, so that the recovery controller 220 obtains original image data (310 and 410). Preferably, the image photographing unit 210 turns on all the light sources 130 to photograph the images.

Then, the image photographing unit 210 photographs the light-transmitting object 100 and the subject 110 after changing spatial distribution of the light beams irradiated onto the light-transmitting object 100. The spatial distribution of the light beams is changed from that of the light beams used when the original image data are obtained. Thereby, the recovery controller 220 obtains the intermediate image data (320 and 420). Preferably, the image photographing unit 210 turns off several light sources 130 among all the light sources 130 and then photographs the light-transmitting object 100 and the subject 110.

According to an exemplary embodiment of the present invention, the recovery controller 220 obtains a single set of intermediate image data through operation 320.

According to another exemplary embodiment of the present invention, the recovery controller 220 obtains a plurality of intermediate image data through operation 420. A plurality of intermediate image data can be obtained by changing spatial distribution of the light beams irradiated onto the light-transmitting object 100 several times and photographing the light-transmitting object 100 and the subject 110 whenever the spatial distribution is changed. Preferably, the spatial distribution of the light beams irradiated onto the light-transmitting object 100 is not overlapped.

The image recovery unit 240 is instructed from the recovery controller 220 to generate the recovered image data by using the original image data and the intermediate image data. The image recovery unit 240 replaces replacement target data among the original image data with reflection-free data to generate the recovered image data (330 and 430). In this case, the reflection-free data may be a portion of the intermediate image data of which pixel values are different from those of the original image data, or may be a portion of the intermediate image data corresponding to the regions of the light-transmitting object 100, of which pixel values are different from those of the original image data. Preferably, the reflection-free data are generated by the emphasis section 242.

According to an exemplary embodiment of the present invention, through operation 330, the image recovery unit 240 replaces the replacement target data among the original image data with the reflection-free data at one time.

According to another exemplary embodiment of the present invention, through operation 430, the image recovery unit 240 preferably replaces each of the replacement target data among the original image data with corresponding reflection-free data. In this case, the replacement target data are replaced with corresponding reflection-free data in a one-to-one manner. That is, each of the replacement target data is matchable to each of the reflection-free data.

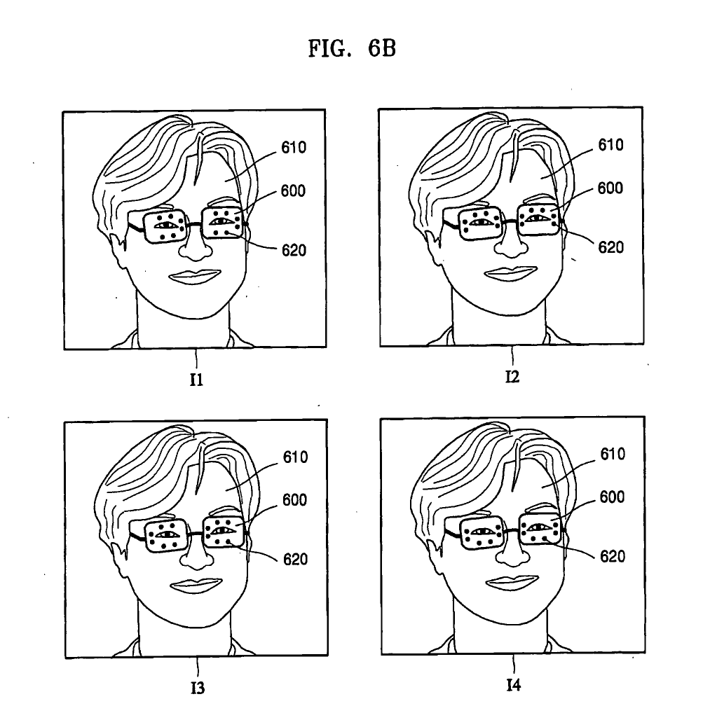

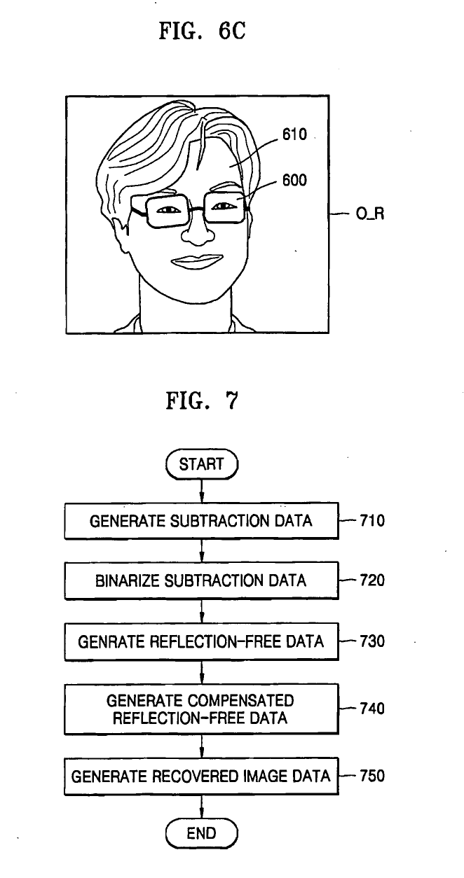

FIGS. 5 and 6 are schematic diagrams for describing flowcharts of FIG. 4.

FIG. 5 is a schematic perspective view illustrating an image photographing unit 210 that can be included in the image processing apparatus shown in FIG. 2 according to the present invention. FIG. 6A illustrates an example of original image data. FIG. 6B illustrates an example of intermediate image data. FIG. 6C illustrates an example of recovered image data.

Here, eight light sources 530 are provided around the lens assembly 520 in such a way that four pairs are located in upper, lower, left and right positions, respectively. The number and the position of the light sources 530 are just for an illustrative purpose, and are not limited by this.

Reference numerals 510, 520, and 530 denote the image photographing unit 210, the lens assembly 140, and the light sources 130, respectively. Reference numerals 600, 610, and 620 denote the light-transmitting object 100, the subject 110, and the mirror reflection regions, respectively.

The spatial distribution of the light beams irradiated onto the light-transmitting object 600 from the light sources 530 is changed by the recovery controller 220 in a plurality of times. Herein, the spatial distribution is preferably changed by selectively turning off a portion of the eight light sources 530. For example, after all the light sources 530 are turned on to photograph, the left pair of light sources 1 and 2 are turned off and the light-transmitting object 100 and the subject 110 are photographed. Then, the lower pair of light sources 3 and 4 is turned off and the light-transmitting object 100 and the subject 110 are photographed. Similarly, the right pair of light sources 5 and 6 is turned off and the light-transmitting object 100 and the subject 110 are photographed. Finally, the upper pair of light sources 7 and 8 are turned off, and the light-transmitting object 100 and the subject 110 are photographed. In other words, the eight light sources 1 through 8 are sequentially turned off. Preferably, the light sources 530 that turned off are changed in every change.

Referring to FIG. 6A, there are mirror reflection regions 620 in the original image data I_O that were obtained by turning on all the light sources 530. The intermediate image data I1 through I4 shown in FIG. 6B are necessary to obtain the recovered image data O_R shown in FIG. 6C by eliminating mirror reflection effect from the original image data.

The intermediate image data are the data obtained by photographing the light-transmitting object 100 and the subject 110 after changing the spatial distribution of the light beams that were irradiated onto the light-transmitting object 600 when the original image data are obtained. Therefore, the possible number of the intermediate image data are not limited by four as shown in FIG. 6B. Instead, in FIG. 6B, since the spatial distribution of the light beams has been changed in four times as described above in consideration of FIG. 5, four intermediate image data I1 through I4 were shown.

The intermediate image data I1 have been obtained by turning off the left pair of light sources 530, and the intermediate image data I2 have been obtained by turning off the lower pair of light sources 530.

Similarly, the intermediate image data I3 have been obtained by turning off the right pair of light sources 530, and the intermediate image data I4 have been obtained by turning off the upper pair of light sources 530.

On the other hand, referring to FIGS. 4 through 6, a plurality of intermediate image data are obtained for one subject 110 and one light-transmitting object 100. If mirror reflection effect is eliminated from the original image data shown in FIG. 6A according to the image processing method shown in FIG. 3, only a portion of the mirror reflection effect may be eliminated. However, if mirror reflection effect is eliminated from the original image data according to the image processing method shown in FIGS. 4 and 6, it is possible to more perfectly eliminate them.

The image processing method shown in FIG. 3 may be useful in a case that the desired data can be obtained when the reflection effect is restricted in a limited area of the subject 110 of the original image data.

For example, it is known that an iris recognition system does not require the entire area of an iris but requires only a portion of the area of an iris. Generally, an image in which 2% of the entire area of an iris is obstructed by reflection can be effectively used to recognize an iris.

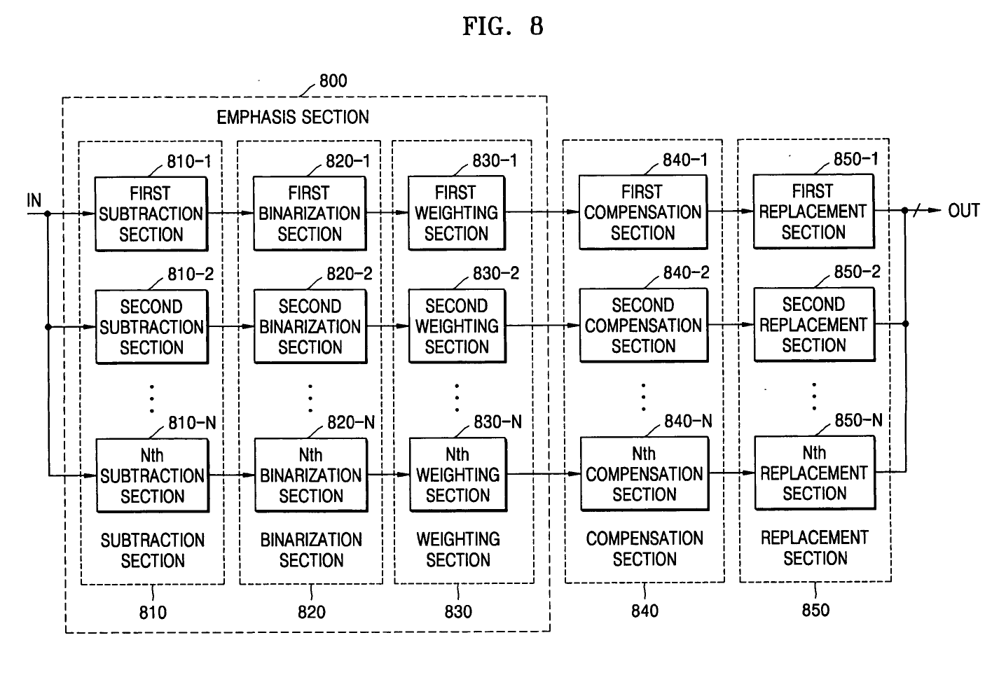

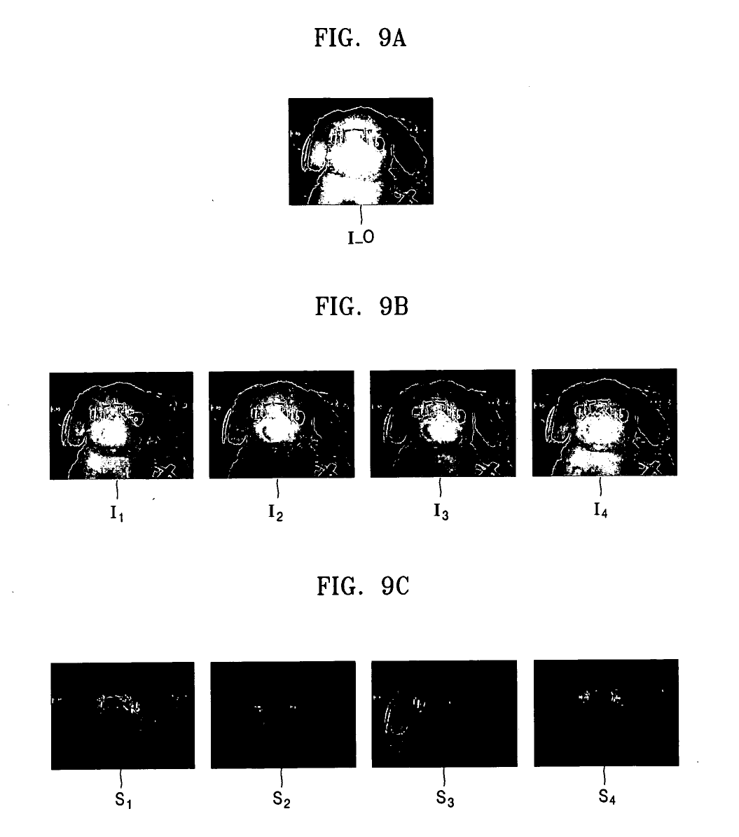

FIG. 7 is a flowchart for describing operation of obtaining the recovered image data (710 through 750) according to an exemplary embodiment of the present invention for operation 330 shown in FIG. 3 and operation 430 shown in FIG. 4. FIG. 8 is a detailed block diagram illustrating an image recovery unit 240 of FIG. 2.

Reference numerals 800, 810, 820, 830, 840, and 850 denote an emphasis section 242, a subtraction section 243, a binarization section 244, a weighting section 245, a compensation section 246, and a replacement section 248, respectively. Also, it is supposed that there are n intermediate image data.

The subtraction section 810 of the emphasis unit 800 generates the subtraction data (operation 710), and the binarization section 820 of the emphasis unit 800 binarizes the subtraction data (operation 720).

The weighting section 830 of the emphasis section 800 multiplies the binarized subtraction data by the intermediate image data to generate reflection-free data (operation 730).

The compensation section 840 adds or subtracts a predetermined value to or from the reflection-free data to generate compensated reflection-free data (operation 740). Alternatively, operation 740 may be not provided for a convenience.

The replacement section 850 replaces the replacement target data among the original image data with the reflection-free data or the compensated reflection-free data to generate the recovered image data (operation 750).

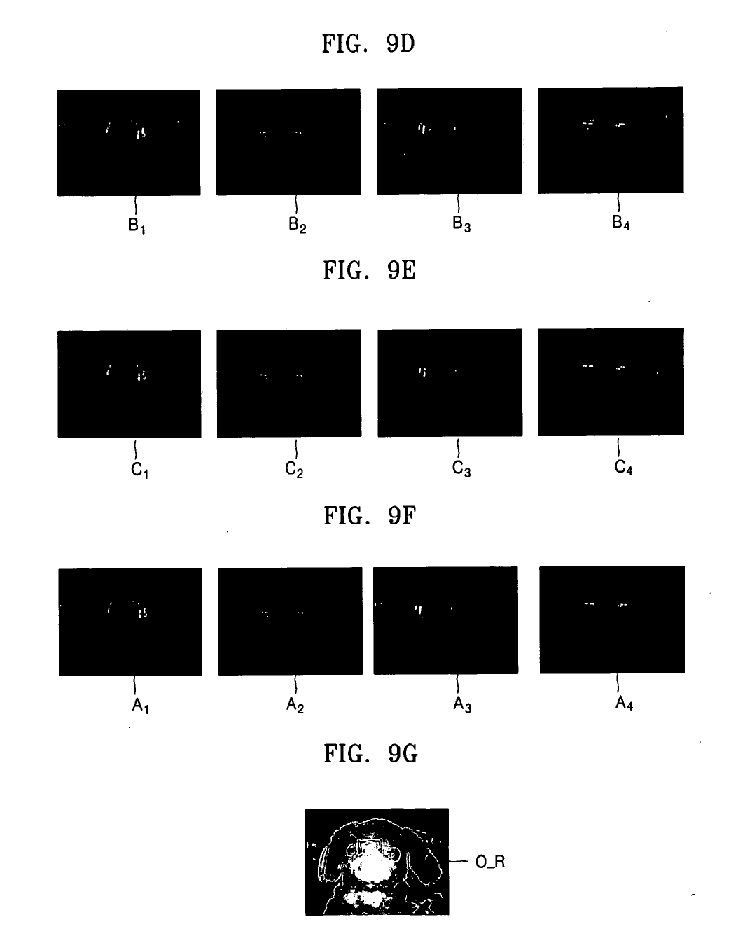

FIGS. 9A through 9G illustrates a process of eliminating mirror reflection regions in the image processing apparatus according to the present invention. Now, FIGS. 7 and 8 will be described in more detail with reference to FIGS. 9A through 9G. For a convenient description, as described in consideration of FIGS. 5 and 6, it is assumed that n is 1 through 4, particularly, n=4 in the following description.

In operation 710, the subtraction section 810 calculates subtraction data S1 through S4 (FIG. 9C), that is, different data between the intermediate image data I1 through I4 (FIG. 9B) and the original image data I_O (FIG. 9A), respectively. For example, S2 is the difference data between 12 and I_O.

Each of the subtraction data has a pixel value within a range from 0 (black) to 255 (white). The subtraction data is calculated for the entire region including the subject 110 and the light-transmitting object 100. The subtraction data S2 corresponding to the regions of the light sources 3 and 4 has a relatively high pixel value because the intermediate image data I2 corresponding to regions of the light sources 3 and 4 has little mirror reflection effect whereas the original image data I_O has mirror reflection effect.

On the contrary, since the pixel value of the intermediate image data I2 corresponding to regions of the light sources 1, 2, 5, 6, 7 and 8 have relatively fewer differences from the original image data I_O, the subtraction data S2 has a relatively low pixel value.

In operation 720, the binarization section 820 binarizes the subtraction data S2 to emphasize the mirror reflection regions.

The binarization of the subtraction data S2 is performed by using a predetermined threshold value. For example, if the pixel value of the subtraction data is higher than a predetermined threshold value, e.g., 200, the pixel is binarized to “1”, otherwise the pixel is binarized to 0. As a result, all the subtraction data S2 are converted into binary “0” or “1”.

The binarization of the subtraction data is to obtain the data of the desired regions among all the subtraction data. In a face recognition apparatus, the subtraction data of the desired regions are the data of the mirror reflection regions 620 appeared on the lenses of a pair of glasses 600 when the light sources 3 and 4 are turned on. The pixel values of the mirror reflection regions 620 among the original image data and the pixel values of the mirror reflection regions 620 among the subtraction data are relatively high.

Finally, if the threshold value is appropriately determined, only the subtraction data of the mirror reflection regions corresponding to the light sources 3 and 4 can be discriminated among all the subtraction data. The binarized subtraction data B2 (FIG. 9D) are preferably the data having “1” for the mirror reflection regions corresponding to the light sources 3 and 4 and having “0” for the remaining regions.

In operation 730, the binarized subtraction data B2 and the intermediate image data I2 are multiplied by each other in the weighting section 830, respectively, to eliminate the intermediate image data corresponding to the remaining regions other than the mirror reflection regions. Finally, in operation 730, the intermediate image data of the mirror reflection regions, that is, the reflection-free data C2 (FIG. 9E) are generated.

In other words, the reflection-free data C2 are obtained by discriminating the data corresponding to the binarized subtraction data B2 from the intermediate image data I2 (FIG. 9B). On the other hand, the reflection-free data C2 are replaced with the data of the mirror reflection regions 620 among all the original image data I_O appeared by the light sources 3 and 4, the mirror reflection effect caused by the light sources 3 and 4 is eliminated from the original image data. As such, if the reflection-free data C2 are replaced with the replacement target data, the mirror reflection effect can be eliminated from the original image data I_O. Therefore, C2 is called the reflection-free data.

In operation 740, the compensated reflection-free data A2 (FIG. 9F) are generated. The compensated reflection-free data A2 are obtained by adding or subtracting a predetermined value to or from the reflection-free data C2. In FIG. 9, the compensated reflection-free data A2 are obtained by adding mean values of the subtraction data S2 to the reflection-free data. As a result, the pixel values of the reflection-free data are increased, so that satisfactory recovered image data can be obtained by using the compensated reflection-free data.

In operation 750, a portion of the original image data I_O of which pixel values are different from the intermediate image data I2 are replaced with the compensated reflection-free data A2.

Referring to FIG. 9G, it is recognized that the mirror reflection regions that can appear in FIG. 9A have been eliminated.

In addition to the above described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code. The code/instructions may form a computer program.

The computer readable code/instructions can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The computer readable code/instructions may be executed by one or more processors.

According to the present invention, an image processing method and an image processing apparatus taking into consideration of light reflection, and a computer readable recording medium storing a program executing the same are adapted to eliminate the mirror reflection effect appeared by the light beams irradiated onto the light-transmitting object. Therefore, a face recognition apparatus or an iris recognition apparatus using infrared rays irradiated onto a face or an iris can be appropriately applied to a person wearing glasses.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An image processing apparatus for irradiating light beams onto a light-transmitting object and a subject located behind the light-transmitting object and photographing the light-transmitting object and the subject to obtain their images, the image processing apparatus comprising:
a recovery controller generating control signals for changing spatial distribution of the irradiated light beams;
an image photographing unit irradiating the light beams in response to the control signals and photographing the light-transmitting object and the subject; and
an image recovery unit replacing replacement target data among original image data, obtained from the image photographing unit by photographing the subject and the light-transmitting object, with reflection-free data to generate recovered image data,
wherein the replacement target data is a portion of the original image data of which pixel values are different from those of intermediate image data obtained by photographing the subject and the light-transmitting object after changing spatial distribution of the irradiated light beams.

2. The image processing apparatus according to claim 1, wherein the recovery controller instructs the image photographing unit to photograph the light-transmitting object and the subject by sequentially changing the spatial distribution of the irradiated light beam.

3. The image processing apparatus according to claim 2, wherein the spatial distribution of the irradiated light beams is not repetitive but sequentially changed.

4. The image processing apparatus according to claim 1, wherein the reflection-free data are a portion of the intermediate image data of the light-transmitting object of which pixel values are different from those of the original image data.

5. The image processing apparatus according to claim 1, wherein the image recovery unit generates the recovered image data by replacing the replacement target data among the original image data with compensated reflection-free data, the compensated reflection-free data are obtained by adding or subtracting a predetermined value to or from the reflection-free data.

6. The image processing apparatus according to claim 1, wherein the image recovery unit comprises:
an emphasis section generating the reflection-free data by binarizing subtraction data representing differences between the intermediate image data and the original image data and multiplying the binarized subtraction data by the intermediate image data; and
a replacement section replacing the replacement target data among the original image data with the reflection-free data generated by the emphasis section to generate recovered image data.

7. The image processing apparatus according to claim 6, wherein the replacement section further comprises a compensation section adding or subtracting a predetermined value to or from the reflection-free data generated by the emphasis section to generate compensated reflection-free data, and
the recovered image data are obtained by replacing the replacement target data among the original image data with the compensated reflection-free data generated by the compensation section.

8. The image processing apparatus according to claim 7, wherein the predetermined value is a mean value of the subtraction data.

9. The image processing apparatus according to claim 1, wherein the light beams irradiated onto the light-transmitting object and the subject are invisible to human beings.

10. The image processing apparatus according to claim 1, wherein the light-transmitting object is a lens of a pair of glasses, and the subject is an iris.

11. The image processing apparatus according to claim 1, wherein the light-transmitting object is a lens of a pair of glasses, and the subject is a face.

12. An image processing method of obtaining images of a light-transmitting object and a subject located behind the light-transmitting object, the image processing method comprising:
obtaining original image data by irradiating light beams onto the light-transmitting object and the subject and photographing the light-transmitting object and the subject;
obtaining intermediate image data by photographing the light-transmitting object and the subject after changing spatial distribution of the irradiated light beams; and
generating recovered image data by replacing replacement target data among the original image data with reflection-free data,
wherein the replacement target data are a portion of the original image data of which pixel values are different from those of the intermediate image data.

13. The image processing method according to claim 12, wherein the intermediate image data are obtained by changing spatial distribution of the irradiated light beams a predetermined number of times and photographing the light-transmitting object and the subject whenever the spatial distribution is changed, so that the number of the intermediate image data corresponds to the predetermined number of times.

14. The image processing method according to claim 12, wherein the reflection-free data are a portion of the intermediate image data of the light-transmitting object of which pixel values are different from those of the original image data.

15. The image processing method according to claim 12, wherein the recovered image data are generated by replacing the replacement target data among the original image data with compensated reflection-free data, and
the compensated reflection-free data are obtained by adding or subtracting a predetermined value to or from the reflection-free data.

16. The image processing method according to claim 12, wherein the recovered image data are generated by: binarizing subtraction data representing differences between the intermediate image data and the original image data and multiplying the binarized subtraction data by the intermediate image data to generate the reflection-free data; and
replacing the replacement target data among the original image data with the generated reflection-free data.

17. The image processing method according to claim 16, wherein the replacing of the replacement target data comprises:
generating compensated reflection-free data by adding or subtracting a predetermined value to or from the generated reflection-free data; and
replacing the replacement target data among the original image data with the compensated reflection-free data.

18. A computer readable recording medium storing a program executing an image processing method for obtaining images of a light-transmitting object and a subject located behind the light-transmitting object, the image processing method comprising:
obtaining original image data by irradiating light beams onto the light-transmitting object and the subject and photographing the light-transmitting object and the subject;
obtaining intermediate image data by photographing the light-transmitting object and the subject after changing spatial distribution of the irradiated light beams; and
generating recovered image data by replacing replacement target data among the original image data with reflection-free data,
wherein the replacement target data are a portion of the original image data of which pixel values are different from those of the intermediate image data.

19. The computer readable recording medium according to claim 18, wherein the intermediate image data are obtained by changing spatial distribution of the irradiated light beams a predetermined number of times and photographing the light-transmitting object and the subject whenever the spatial distribution is changed, so that the number of the intermediate image data corresponds to the predetermined number of times.

20. The computer readable recording medium according to claim 18, wherein the reflection-free data are a portion of the intermediate image data of which pixel values are different from those of the original image data.

21. An image processing apparatus for irradiating light beams onto a light-transmitting object and a subject located behind the light-transmitting object and photographing the light-transmitting object and the subject to obtain their images, the image processing apparatus comprising:
a recovery controller generating control signals for changing spatial distribution of the irradiated light beams;
an image photographing unit irradiating the light beams in response to control signals and photographing the light-transmitting object and the subject whenever the spatial distribution is changed to obtain original image data and intermediate image data; and
an image recovery unit replacing replacement target data among original image data, obtained from the image photographing unit by photographing the subject and the light-transmitting object, with reflection-free data to generate recovered image data,
wherein the replacement target data and reflection-free data is determined based on comparison of the original image data with the intermediate image data.

22. An image processing method of obtaining images of a light-transmitting object and a subject located behind the light-transmitting object, the image processing method comprising:
obtaining original image data by irradiating light beams onto the light-transmitting object and the subject and photographing the light-transmitting object and the subject;
obtaining intermediate image data by photographing the light-transmitting object and the subject after changing spatial distribution of the irradiated light beams; and
generating recovered image data by replacing replacement target data among the original image data with reflection-free data,
wherein the replacement target data and the reflection-free data are determined based on a comparison of the original image data and the intermediate image data.

23. At least one computer readable medium storing instructions that control at least one processor to perform a method comprising:
obtaining original image data by irradiating light beams onto the light-transmitting object and the subject and photographing the light-transmitting object and the subject;
obtaining intermediate image data by photographing the light-transmitting object and the subject after changing spatial distribution of the irradiated light beams; and
generating recovered image data by replacing replacement target data among the original image data with reflection-free data,
wherein the replacement target data and the reflection-free data are determined based on a comparison of the original image data and the intermediate image data.
